(19) United States
(12) Patent Application Publication
(10) Pub. No.: US 2015/0007757 A1
(43) Pub. Date: Jan. 8, 2015

(54) Mobile Bi-Level Bed Cover Storage Unit

(71) Applicant: BRIAN GEORGE EDDY, Longwood, FL (US)

(72) Inventor: BRIAN GEORGE EDDY, Longwood, FL (US)

(21) Appl. No.: 14/321,800

(22) Filed: Jul. 1, 2014

Related U.S. Application Data
(60) Provisional application No. 61/802,356, filed on Jul. 3, 2013.

(51) Int. Cl. A47C 21/02; F16N 99/00

(52) U.S. Cl. CPC A47C 21/022; F16N 99/00
USPC 108/102; 184/109

(57) ABSTRACT

Various methods are used to store bedcovers such as thick quilts and comforters when not in use. Previous methods and apparatus for such storage were bulky, not easily adjustable or movable. The present invention, however, provides for a greatly improved method and apparatus that does not interfere with the actual bed structure and is easily movable and adjustable.

The present invention describes the methodology utilized to achieve these goals.

### BACKGROUND OF THE INVENTION

1. Field of Invention

This invention relates to a method and stand-alone apparatus for storing bed covers when not in use. Non-specialized methods of temporarily storing these covers and pillows include chests, closets, draping on furniture or simply piling them in a corner of the room. The instant invention is not only functional, but elegant in its design as the preferred embodiment has the appearance of fine furniture.

2. Background of the Prior Art

Previous methods of constructing an apparatus specifically for the storage of bed covers include various types of platform-type structures upon which the covers and materials can be laid. These designs have included some type of platform with hinge mechanisms. Further, they are limited in their ability to provide an effective method of bed cover storage without some kind of direct connection to the bed itself. U.S. Pat. No. 5,699,565 to Petterborg, which most closely resembles the instant invention, requires “The collapsible bedspread holder according to claim 2 wherein said means for pivotally anchoring said quadrilateral frame in close juxtaposition to one end of the bed, includes a pair of spaced and parallel anchor rods adapted be disposed between the underside of the mattress and the top of the box spring.” Our invention is a stand-alone bed cover storage unit that requires no such mechanism.

Again, in claim 2 of U.S. Pat. No. 5,509,158 to Morrison, “struts are elongate[d] for extension between a mattress and box spring of the bed.” In U.S. Pat. No. 5,305,480, to Loren, again, the invention relies on connection to the bed itself as it is described in claim 1, “a flat stationary anchoring member having a front portion and rear portion, and designed to be disposed at least almost entirely between said mattress and said springs.” Finally, as described in U.S. Pat. No. 3,961,385 to Ferry, we see in claim 1 “A foldable placement platform adaptable for mounting to the mattress and spring support unit of a bed for the support of the bedspread of the bed when the bedspread has been removed from the bed, said platform hinged to a frame member fitted with attachment means, with folding legs fitted to the underside of the platform . . . ”

As seen in the prior art, there are several limitations. The chief one described thoroughly as the requirement for some kind of attachment, connecting or mounting to the bed itself. Further, all of the bed cover storage units described in the prior art are single level stationary units. While some are collapsible through a hinge, they cannot be easily moved or placed for functional use in a different location.

### SUMMARY OF THE INVENTION

Our present invention overcomes the limitations of the prior art in several ways. First of all, we provide a unique, adjustable bi-level bed-cover storage unit further described below, which allows the user to completely collapse the storage unit to approximately 6 inches in height such that it can be stored under the bed without any unsightly hardware exposed. Second, in our novel design, the storage unit is a completely stand-alone unit without the need for any type of connection, attachment or mounting to the bed itself. Third, through the combined use of wheels, tracks, casters, piano hinges for adjustable height capability the limitations above described are overcome. Finally the bi-level design allows for greater storage capability.

It is further noted herein that while the preferred embodiment of the instant invention is for the purpose of providing bed cover storage, the nature of the design is multi-purpose. Additional braces may be utilized to further strengthen the apparatus such that it may be utilized for seating. It may also be considered for use as a mobile desk that can be brought bed-side as well.

### BRIEF DESCRIPTION OF THE DRAWINGS

The detailed description of the invention, contained herein below, may be better understood when accompanied by a brief description of the drawings, wherein:

FIG. 1 is a diagram illustrating a top view of the bed cover storage unit. This figure also shows the functional handle slits.

FIG. 2 shows an overall extended view which clearly shows the top or primary level and secondary level for storage of bed covers, pillows or other items. Also shown is a view of the wheels and casters.

FIG. 3 is a diagram showing the apparatus in collapsing mode.

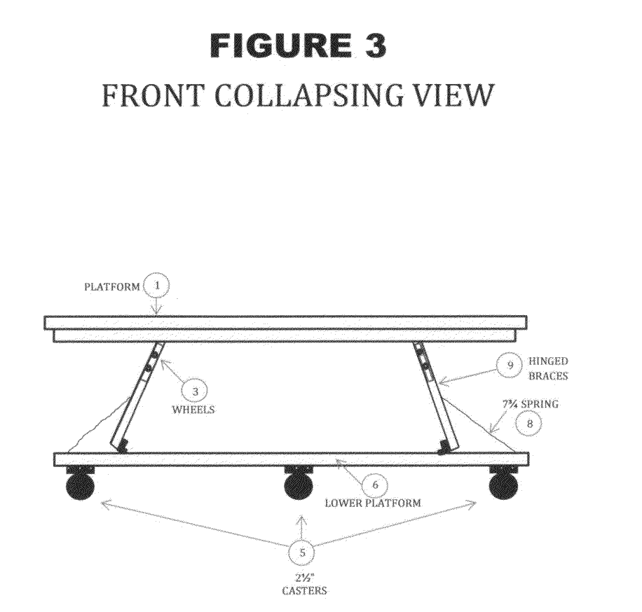

FIG. 4 shows an overall view of the apparatus in its collapsed position.

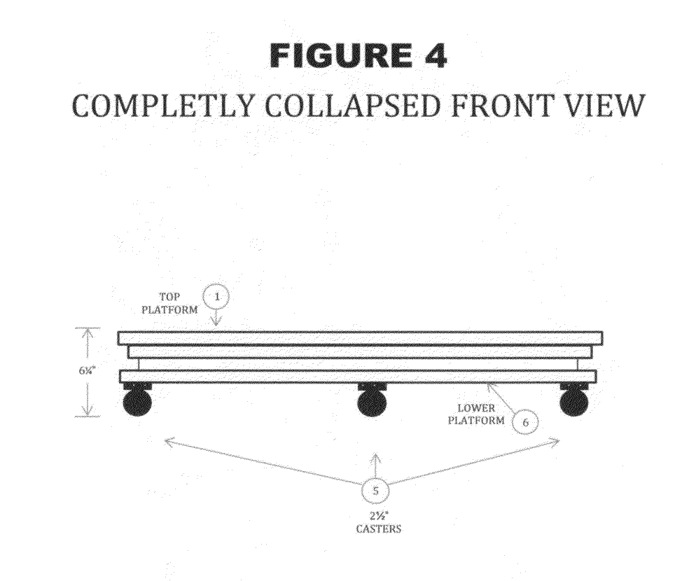

FIG. 5 is a detailed extended side view

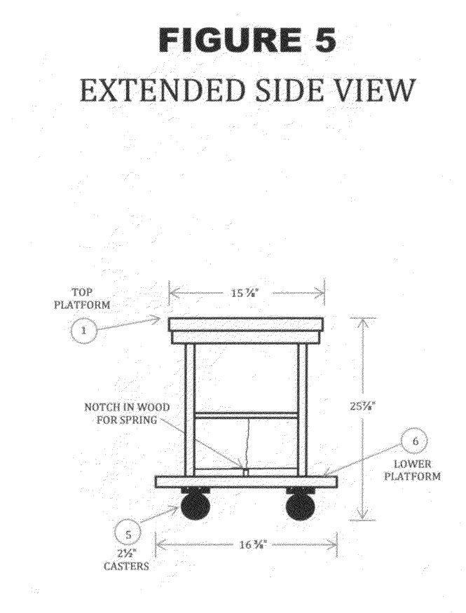

FIG. 6 provides a view of the underside of the top or primary level of the apparatus

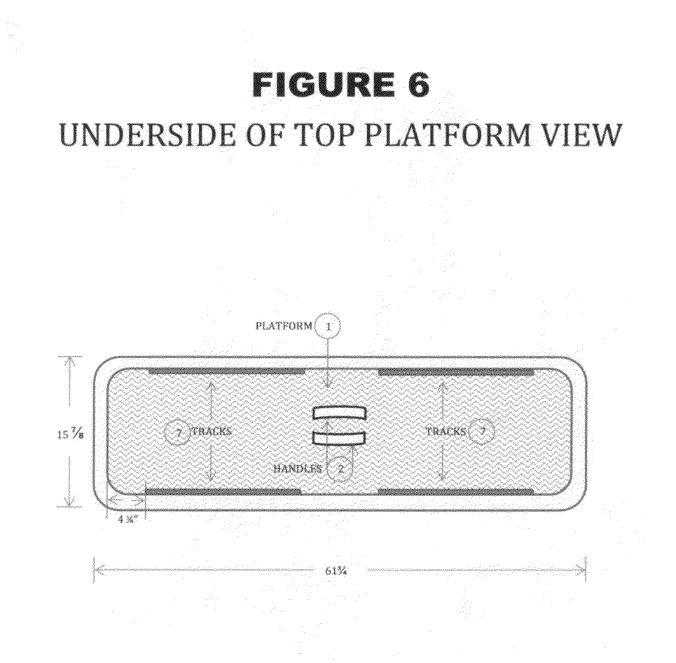

FIG. 7 provides a detailed view of the leg side

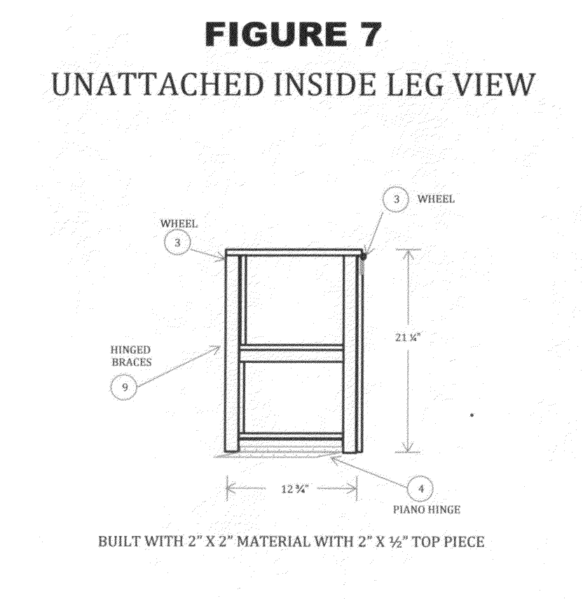

### DETAILED DESCRIPTION OF THE PREFERRED EMBODIMENT

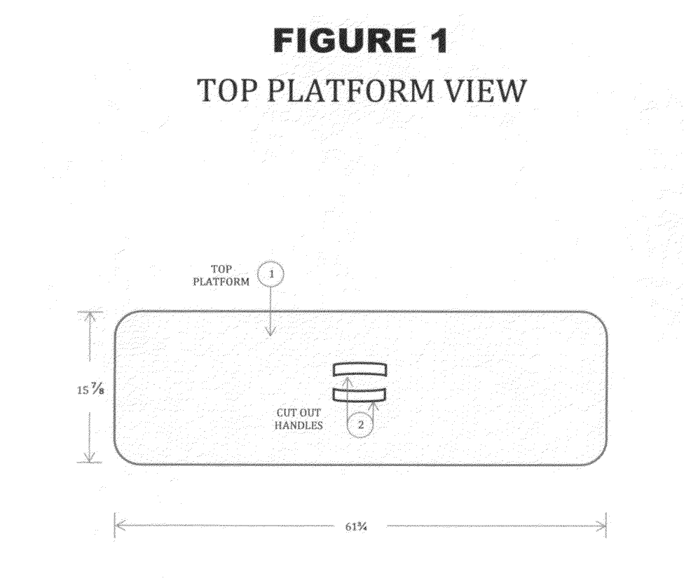

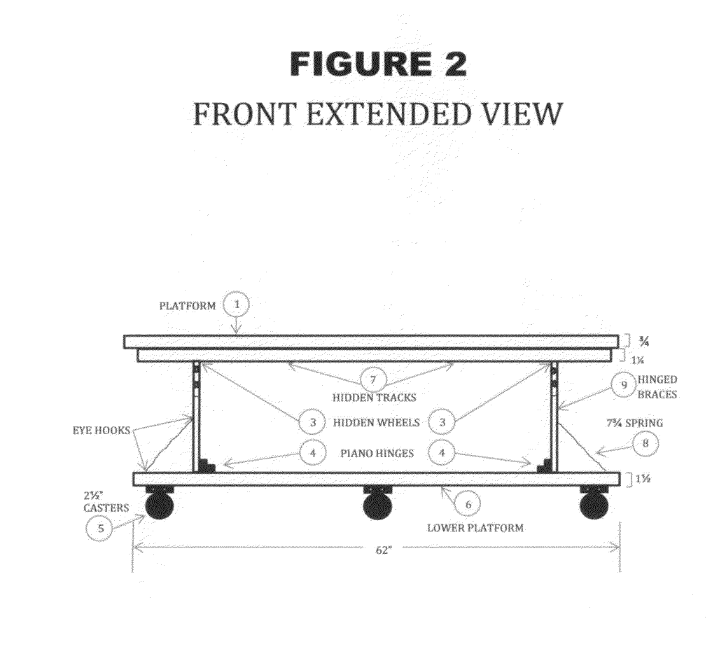

While the preferred embodiment shown herein is constructed of wood, nothing herein prevents the use of alternate materials such as steel or aluminum from being used. As shown in FIG. 1, there is a solid platform material (1) in the preferred embodiment to be approximately 15⅞ inches in width to allow for the top-level storage platform. For ease of use, there is a cut out handle (2) that allows the user of the apparatus to raise and lower the bed cover storage unit. Further, the handles (2) are flush with platform (1) such that there is no interference with anything (e.g. bed-covers) placed on the platform (1). Additionally, the design of the handles (2) prevents any interference when the apparatus is collapsed and placed under the bed. As can be seen in the extended view in FIG. 2, wheels (3), tracks (7), piano hinges (4) and springs (8) are utilized to achieve the raising and lowering of the unit. The hinged braces (9) provide support and stability when the mobile bi-level bed cover storage unit erect.

The lower level platform material (6) can house pillows or additional materials while in the raised position. Finally, the casters (5) are utilized for mobilizing the bi-level bed cover storage unit.

It is noted that while the preferred embodiment identifies wheels and tracks, it is anticipated that an alternate embodiment may employ the use of hydraulic means or ball bearing tracts with retractable springs within. The specific size described is not meant to be a limitation. The preferred embodiment is designed for a king bed; however, the same design may be modified to meet other bed sizes such as a queen, twin or a full/double bed.

Having thus described the present invention in the detailed description of the preferred embodiment, what is desired to be obtained by Letters Patent is:

1. A stand-alone bed-cover storage unit comprising
a. A top-level platform structure connected to a bottom level platform structure by means of four folding, hinged braces.
b. The bi-level bed cover storage unit described employs wheel and track, hinge and spring components to allow for the raising and lowering of said unit.
c. The bi-level bed cover storage unit described further employs casters for the purpose of mobility.
d. The bi-level bed cover storage unit described herein is made of fine wood.

2. The stand-alone bi-level bed cover storage unit comprising the elements described in claim 1 with the following alternate elements:
a. Rather than using the components described in claim one to allow for the raising and lowering of said unit, a hydraulic mechanism or a ball-bearing tract system with retractable springs within may be utilized.
b. Rather than using wood as the construction material, other materials such as plastic, composite material or metal may be used.

3. A specific method of supplying oil containing minimal debris (if any) to roller lifter bearings comprising the oil band system dedicated to providing the supply of oil to the roller lifter bearings in which the supply hole(s) are an intricate element.
